(19) United States
(12) Patent Application Publication
(10) Pub. No.: US 2012/0265569 A1
(43) Pub. Date: Oct. 18, 2012

(54) DETERMINING WORK PLACEMENT PREFERENCES

(76) Inventors: Maria-Teresa Gonzalez-Diaz, Mountain View, CA (US); Cynthia L. Glovinsky, Huron, OH (US); Cipriano A. Santos, Modesto, CA (US); Xin Zhang, San Jose, CA (US); Shailendra K. Jain, Sunnyvale, CA (US)

(21) Appl. No.: 13/088,161

(22) Filed: Apr. 15, 2011

(51) Int. Cl. G06Q 10/00

(52) U.S. Cl. 705/7.12

(57) ABSTRACT

Example methods, apparatus and articles of manufacture to determine work placement preferences are disclosed. A disclosed example method includes receiving, via a processor, a request for a resource to fill an open position within an organization, the request including a primary resource group for the open position, determining with the processor resource group preferences of resource groups using a structure of the organization that includes functional relationships between the resource groups, calculating weights for the resource group preferences based on respective organizational distances in the structure of the respective resource groups from the primary resource group, determining a target resource group with a greatest calculated weight for a resource group preference from among the resource groups that have at least one available resource, and selecting a resource within the target resource group to fill the open position.

### BACKGROUND

Many global and large national organizations employ thousands of permanent and contingent workers and contractors (e.g., resources) to deliver services and products to customers. A concern for many of these organizations is workforce planning to select resources with certain skills for an appropriate position at a relevant time and at an efficient cost. Many organizations operate in a dynamic environment and, as a result, allocating resources between functional work groups can consume relatively large amounts of time while not always resulting in the optimal resource selection.

### BRIEF DESCRIPTION OF THE DRAWINGS

FIG. 1 is a schematic illustration of an example system constructed pursuant to the teachings of this disclosure to determine work placement preferences for an organization.

FIG. 2 shows an example structure for the example system of FIG. 1.

FIG. 3 shows an example work placement preference routine for the example system of FIG. 1.

FIG. 4 shows an example structure including example first preferences for two different example work placement cases.

FIG. 5 shows the example structure of FIG. 4 including example second preferences for the two example work placement cases.

FIG. 6 shows the example structure of FIGS. 4 and 5 including example third preferences for the two example work placement cases.

FIG. 7 shows the example structure of FIGS. 4-6 including an example fourth preference for the two example work placement cases.

FIGS. 8A, 8B, 9A, and 9B are flowcharts representative of example machine-accessible instructions, which may be executed to implement the example system and/or resource sourcing processor of FIG. 1.

FIG. 10 is a schematic illustration of an example processor platform that may be used and/or programmed to execute the example processes and/or the example machine-accessible instructions of FIGS. 8A, 8B, 9A, and 9B to implement any or all of the example methods, apparatus and/or articles of manufacture described herein.

### DETAILED DESCRIPTION

Currently, many resource planning personnel in relatively large organizations (e.g., corporations, governments, conglomerates, companies, etc.) have to search databases of resources (e.g., employees, workers, contractors, etc.) to determine which resource should fill an open position and/or provide skills and/or labor to a project team. In some instances, the resource planning personnel may use tools that filter resources by search criteria including, for example, work placement parameters. However, in these instances, resource planning personnel have to manually maintain the search terms, maintain the work placement parameters, and/or manually select a resource from lists of available unfiltered resources. Resource work placement parameters include, for example, a location, a business domain, a job level, a skill group, a workforce type, a travel preference, an education level, or a job type.

In organizations that include thousands to hundreds of thousands of resources, resource planning can be relatively inefficient and time consuming. For example, resource planning personnel typically have to maintain resource work placement parameters, determine which resources are available to be allocated, and manage resource searches to locate which resource should fill an open position. In some instances, resource planning personnel may not select an optimal resource to fill an open position. Further, as organizations attempt to become dynamic by rapidly adapting to changes in business strategy, current known methods of resource planning may slow organizational change by inefficiently reassigning resources.

Example methods, apparatus, and articles of manufacture disclosed herein address at least some of these problems and improve the efficiency of resource planning by using a systemic method for determining work placement preferences based on functional distances of resources (e.g., organizational distances between resources) and matching work placement parameters. An organizational distance is based on relationships between resource groups. In many organizations, resource groups are specified to, for example, report to one or more resource group(s) and/or provide instructions and/or support to one or more resource group(s). Resource groups that report to and/or instruct other resource group(s) are functionally directly linked and/or coupled to the other resource group(s). An organizational distance is a number of resource groups linked and/or coupled together that are between two resources and/or between a resource and a resource group.

The example methods, apparatus, and articles of manufacture disclosed herein determine work placement preferences by creating a structure (e.g., a hierarchical organization structure) that includes resource groups linked together based on functional relationships. To create resource groups, the example methods, apparatus, and articles of manufacture disclosed herein identify a group of resources that can be logically combined together in a resource group. For example, resources allocated to a group may share a manager, location, project customer, service offering, capability, and/or functional unit.

The example methods, apparatus, and articles of manufacture disclosed herein link together resource groups based on an organizational structure including, for example, business units, regions, country, work center, business vertical arrangement, practice group, and/or team. In some examples, available resources may be included within delivery resource groups that are functionally at the lowest level of an organizational structure that is bound together by reporting manager resource groups. In other examples, available resources may be included within any resource groups of an organizational structure. In this manner, the example methods, apparatus, and articles of manufacture disclosed herein encapsulate business rule preferences in a dynamic organizational structure.

To determine which resource is to fill an open position, the example methods, apparatus, and articles of manufacture disclosed herein identify a primary resource group based on a request for a resource. The primary resource group identifies a requested resource group selected to fill an open position. In some examples, the primary resource group may also include the open position. The example methods, apparatus, and articles of manufacture disclosed herein use the primary resource group to determine resource group preferences based on an organizational distance between the primary resource group and other resource groups. The example methods, apparatus, and articles of manufacture disclosed herein assign weights to resource groups based on a ranking and/or ordering of the resource group preferences. In this manner, the example methods, apparatus, and articles of manufacture disclosed herein enable available resources to be allocated beyond immediate, requested, and/or adjacent resource groups.

To determine resource group preferences, the example methods, apparatus, and articles of manufacture disclosed herein identify (e.g., classify) children resource groups, sibling resource groups, and/or cousin resource groups for a primary resource group. A child resource group is a resource group that is functionally lower and directly coupled to a primary resource group. A sibling resource group is a resource group that is functionally at a same level as a primary resource group and shares a parent resource group. A parent resource group is functionally higher and one-hop away from a primary resource group. A cousin resource group is a resource group that is functionally at a same level as a primary resource group and shares a grandparent, great grandparent, etc. resource group. The example methods, apparatus, and articles of manufacture disclosed herein may also determine preferences for business location resource groups (e.g., best shore resource groups or regional resource pools), which are resource groups that may be in a different geographic location from a primary resource group.

The example methods, apparatus, and articles of manufacture disclosed herein use a classification (e.g., child sibling, cousin, business locations, etc) of the resource groups in relation to a primary resource group to determine resource group preferences. For example, children resource groups are preferred over sibling, cousin, and business location (e.g., regional) resource groups, sibling resource groups are preferred over cousin and business location resource groups, and cousin resource groups are preferred over business location resource groups. The example methods, apparatus, and articles of manufacture disclosed herein use the resource group preferences to assign a weight to each resource group. The example methods, apparatus, and articles of manufacture disclosed herein select an available resource from resource group(s) with the greatest weight. In instances where a resource group has a greatest weight but no available resources, the example methods, apparatus, and articles of manufacture disclosed herein select available resources from a resource group that has the next greatest weight.

In some examples, the example methods, apparatus, and articles of manufacture disclosed herein may combine calculated weights of resource groups with scores for work placement parameters of available resources matching work placement parameters of the open position. The example methods, apparatus, and articles of manufacture disclosed herein may then select an available resource with a score that exceeds a threshold and/or may select an available resource with a greatest score. In this manner, the example methods, apparatus, and articles of manufacture disclosed herein utilize a desired position in an organization structure and relationships among resource groups to quantify weights used to select a best available resource that is chosen based on a preference to be as organizationally close as possible to an open position.

Resource planning personnel may use the example methods, apparatus, and articles of manufacture disclosed herein to efficiently and quickly assign resources to open positions to maintain a dynamic organization. The resource planning personnel may also use the example methods, apparatus, and articles of manufacture disclosed herein to evaluate resources at other locations within an organization to fill gaps in resources, maintain project teams with resources from relatively close resource groups, and/or examine preferred business location resources for an open position. Further, resource planning personnel may use the example methods, apparatus, and articles of manufacture disclosed herein to modify weights, scores, and/or an organizational structure based on changing business conditions without causing delays in resource allocation.

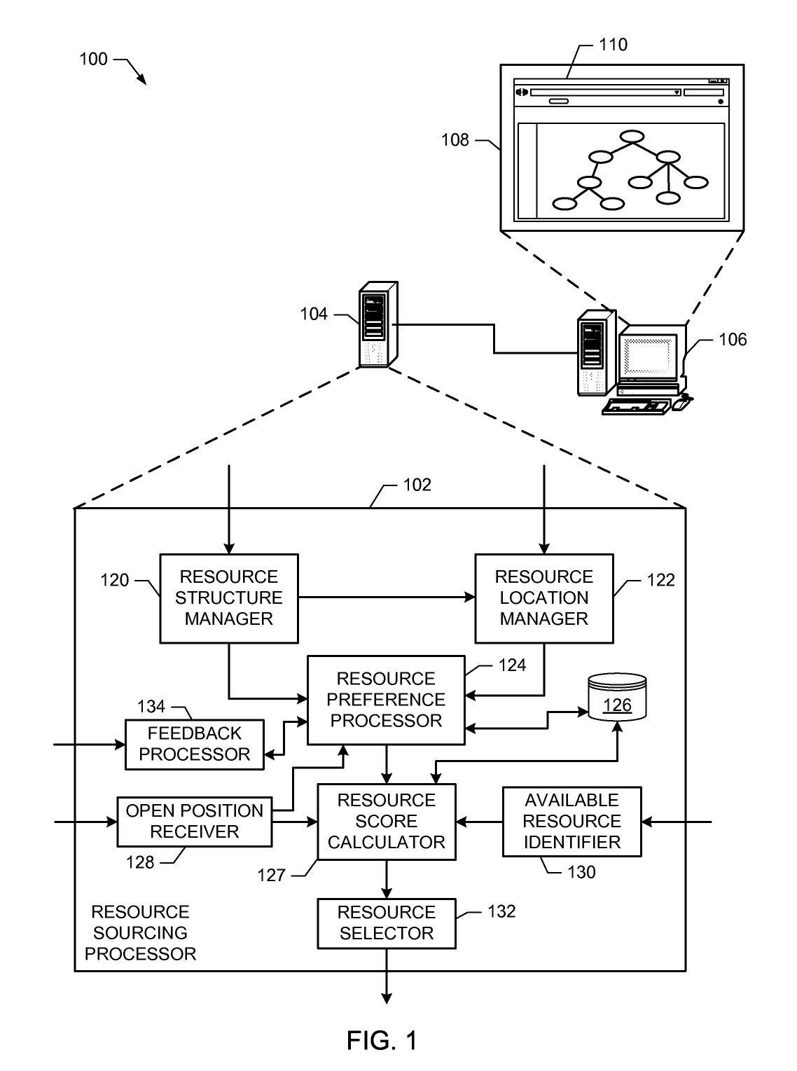

FIG. 1 shows an example system 100 constructed in accordance with the teachings of the disclosure to determine work placement preferences via a resource sourcing processor 102. The example resource sourcing processor 102 determines a resource to fill an open position using organizational distances of resource groups to identify preferred available resources within, for example, an organizational structure. The example resource sourcing processor 102 also determines a resource to fill an open position by matching work placement parameters specified within a request for the open position to work placement parameters of available resources.

In the illustrated example, the resource sourcing processor 102 is included within a server 104 that is accessible by a workstation 106. The example server 104 may include any processor, computer, computing center, distributive computing environment, etc. for allocating resources within an organization. In some examples, the server 104 may be included within the workstation 106.

The example workstation 106 may be implemented by any type of computing device including, for example, a personal computer, a server, a laptop, a smartphone, a smartpad, etc. In the illustrated example, the workstation 106 includes an operating system and a display monitor. The example workstation 106 may be communicatively coupled to the server 104 via a network (e.g., the Internet, a Local Area Network, etc.). The example workstation 106 enables resource planning personnel to request resources to fill open positions and/or request to allocate resources within an organization. While the example of FIG. 1 shows the workstation 106 communicatively coupled to the server 104, in other examples, multiple workstations (not shown) may be communicatively coupled to the server 104.

To enable resource planning personnel to request resources and/or to view candidate resources, the example workstation 106 includes a user interface 108. The example user interface 108 enables resource planning personnel to interact with the example resource sourcing processor 102 to allocate resources. In some examples, resource planning personnel may use the example user interface 108 to provide organizational information that the example resource sourcing processor 102 uses to construct an organizational structure and determine resource group preferences. Resource planning personnel may also use the example user interface 108 to provide weights and/or scores that the example resource sourcing processor 102 uses to select and/or match resources to an open position. Further, resource planning personnel may use the example user interface 108 to provide available positions and/or specify work placement parameters.

In the illustrated example of FIG. 1, the user interface 108 displays an application 110 for selecting and/or allocating resources within an organization. Resource planning personnel may interact with the application 110 to request, select, and/or specify resources for an open position. The example application 110 includes any resource management tool that resource planning personnel may use to allocate resources within an organization.

To determine an organizational structure for an organization, the example resource sourcing processor 102 includes a resource structure manager 120. The example resource structure manager 120 receives organization information from, for example, the workstation 106 and/or any other computing device within an organization. In other examples, the resource structure manager 120 may access organizational charts of an organization stored in resource planning databases. The organization information includes, for example, resource groups, resources assigned to each resource group, and functional relationships between the resource groups.

After receiving the organization information, the example resource structure manager 120 of FIG. 1 determines a structure and determines functional relationships between the resource groups. In some examples, the resource structure manager 120 may create a hierarchal structure based on the organization information. In other examples, the resource structure manager 120 may determine that an organization has a vertical, horizontal, and/or matrix structure.

To determine which resource groups are associated with which business locations (e.g., regions), the example resource sourcing processor 102 includes a resource location manager 122. The example resource location manager 122 uses organization information and the structure determined by the resource structure manager 120 to determine which resource groups are included within a business unit (e.g., a set) that is associated with a physical location. The organization information may include location information that specifies where resources and/or resource groups are physically located. The example resource location manager 122 may modify the structure so that resource groups are organized based on functions and/or geographic locations.

For example, the resource location manager 122 may determine that some resource groups are associated with a California location while other resource groups are associated with a Bangalore, India location. The example resource location manager 122 groups the resource groups associated with California into a first location and groups the resource groups associated with Bangalore into a second location. The example resource sourcing processor 102 may then use the business location information when determining preferences for resource groups based on a primary resource group. In other words, the example resource sourcing processor 102 uses the business location information to initially locate available resources located within the same location as an open position. The example resource sourcing processor 102 may then look to resources in other locations if there are no available resources in the same location as an open position. In this manner, the example resource location manager 122 modifies a structure of an organization so that resources located relatively closer to an open position are preferred over resources located relatively farther away.

To determine resource group preferences based on a determined organizational structure, the example resource sourcing processor 102 of the illustrated example includes a resource preference processor 124. The example resource preference processor 124 uses the structure from the resource structure manager 120 and/or the resource location manager 122 to determine resource group preferences of resource groups. The example resource preference processor 124 also determines organizational distances between resource groups to calculate weights for each of the resource group preferences. In this manner, the example resource preference processor 124 creates a preferences matrix (e.g., a multidimensional preferences matrix) that is used to determine which resource should fill an open position.

In some examples, the example resource preference processor 124 of FIG. 1 determines resource group preferences and/or weights in relation to a primary resource group. The primary resource group corresponds to a resource group that has an open position specified by resource planning personnel to be filled by the resource sourcing processor 102. In other examples, the resource preference processor 124 determines resource group preferences and/or weights for each resource group with a structure. By determining preferences and/or weights for each resource group, the example resource preference processor 124 enables the resource sourcing processor 102 to relatively easily identify predetermined preferences for a primary resource group when a request to fill an open position is received.

To determine resource group preferences, the example resource preference processor 124 identifies a resource group as a primary resource group. The example resource preference processor 124 then identifies children resource groups. The children resource groups may be resource groups that are directly linked functionally below the primary resource group. In some instances, the children resource groups may include available (e.g., deliverable) resources for a specified higher level resource group. The example resource preference processor 124 classifies the children resource groups as a first preference.

The example resource preference processor 124 also determines sibling resource groups and cousin resource groups. The resource preference processor 124 identifies the sibling resource groups as a second preference and the cousin resource groups as a third preference. The example resource preference processor 124 may then determine other location resource groups as a fourth preference. Additionally, the resource preference processor 124 may determine some resource groups are associated with a fifth or higher preference. Alternatively, the example resource preference processor 124 may determine that resource groups are associated with three or fewer preferences based on a structure of the organization and/or preferences of resource planning personnel.

In other examples, the resource preference processor 124 may assign resource groups to a first preference that are one-hop away from a primary resource group. In these other examples, the resource preference processor 124 may also assign resource groups to a second preference that are two-hops away from a primary resource group and assign resource groups to a third preference that are three or more hops away from the primary resource group. In these examples, the resource preference processor 124 may assign resource groups to a fourth preference that are in a different location from the primary resource group. In yet other examples, the resource preference processor 124 may determine preferences based on other criteria and/or business rules of an organization such as, for example, a job level, a skill group, a workforce type, a travel preference, an education level, etc.

The example resource preference processor 124 of FIG. 1 calculates weights for each resource group based on a determined preference classification for the resource groups and an organizational distance within a structure of the resource groups from a primary resource group. The resource preference processor 124 may calculate the weight using an algorithm and/or routine. For example, the weight may be approximately inversely proportional to a number of hops of a resource group from a primary resource group. In other examples, the resource preference processor 124 may calculate a weight using a table and/or list that references to a preference and/or organizational distance. For example, resource groups within a first preference may correspond to a 100 weight, resource groups within a second preference may correspond to a 90 weight, resource groups within a third preference may correspond to a 80 weight, and resource groups within a fourth preference may correspond to a 60 weight.

After determining preferences for resource groups and/or weights for resource groups, the example resource preference processor 124 of the illustrated example stores the preferences, weights, structure, and/or preferences matrix to a resource database 126. The example resource database 126 enables the resource sourcing processor 102 to identify which resource groups are preferred based on a selected primary resource group. In some examples, resource planning personnel may access the resource database 126 to view a structure, relationships between resource groups, and/or which resource groups are preferred to other resource groups. The example resource database 126 may be implemented by, for example, storage disk(s) disk array(s), tape drive(s), volatile and/or non-volatile memory, compact disc(s) (CD), digital versatile disc(s) (DVD), floppy disk(s), read-only memory (ROM), random-access memory (RAM), programmable ROM (PROM), electronically-programmable ROM (EPROM), electronically-erasable PROM (EEPROM), optical storage disk(s), optical storage device(s), magnetic storage disk(s), magnetic storage device(s), cache(s), and/or any other storage media in which data is stored for any duration.

To calculate scores for available resources to fill an open position, the example resource sourcing processor 102 of FIG. 1 includes a resource score calculator 127. The example resource score calculator 127 calculates scores for available resources by matching work placement parameters of available resources to work placement parameters specified within a request to fill an open position. The work placement parameters include, for example, a location, a business domain, a job level, a skill group, a workforce type, a travel preference, an education level, a promotion trend, and/or a job type.

The example resource sourcing processor 102 of the illustrated example uses any routine, algorithm, formula, and/or equation for calculating a score based on how much work placement parameters of available resources match work placement parameters associated with an open position. For example, the resource sourcing processor 102 may determine a numeric value based on how close of a match there is for each work placement parameter. The example resource sourcing processor 102 may then aggregate and/or calculate a score based on the determined numeric values. In some examples, the calculation may incorporate different weight values assign to the types of work placement parameters.

After calculating a score for the available resources, the example resource sourcing processor 102 of FIG. 1 uses the resource group preferences and/or weights to adjust the score for each resource. For example, the resource sourcing processor 102 may initially calculate a score of 85 for an available resource. The example resource sourcing processor 102 accesses the resource database 126 to determine that the available resource is included within a resource group that is classified as a second preference and has an assigned weight of 80. The resource sourcing processor 102 adjusts the initial score of 85 by the 80 weight resulting in an adjust score of 82.5. In other examples, the resource sourcing processor 102 may use any equation, function, algorithm, and/or routine for adjusting a score based on resource group preferences and/or weights.

To determine which resource group is to be the primary resource group for calculating resource scores, the example resource sourcing processor 102 includes an open position receiver 128. The example open position receiver 128 receives requests to fill open positions from, for example, the workstation 106. In other examples, the open position receiver 128 may access databases of open positions within an organization. In addition to receiving an identifier of an open position, the example open position receiver 128 may receive work placement parameters associated with an open position. In many instances, resource planning personnel may specify the work placement parameters for an open position as requirements and/or recommendations for the position. In other instances, the open position receiver 128 may determine work placement parameters based on an open position type. For example, an open position for a Level 3 Hardware Engineer in California may correspond to a predefined set of work placement parameters.

An open position received by the example open position receiver 128 of FIG. 1 corresponds to a primary resource group. In some examples, the resource group to fill the open position (e.g., the primary resource group) may be specified within a request. In other examples, the open position receiver 128 may identify the primary resource group based on information within the request specifying work placement preferences for the open position. After identifying the primary resource group, the example open position receiver 128 transmits the primary resource group to the resource score calculator 127, which then scores available resources. In some instances, the open position receiver 128 may also forward the primary resource group to the resource preference processor 124 to determine preferences and/or weights of resource groups in relation to the specified primary resource group.

To determine which resources within resource groups are available to fill an open position, the example resource sourcing processor 102 of FIG. 1 includes an available resource identifier 130. The example available resource identifier 130 receives inputs of available resources from, for example, the workstation 106. In other examples, the available resource identifier 130 may access one or more databases in an organization that identify which resources are available to be allocated. For example, as projects finish, resource planning personnel and/or managers may list resources that will be available within days, weeks, and/or months.

The available resource identifier 130 receives indications of available resources and determines corresponding resource groups. In some examples, the available resource identifier 130 may identify resource groups based on work placement parameters associated with available resources. In other examples, the available resource identifier 130 may determine which resource groups are associated with which resources based on resource type and/or information provided by resource planning personnel.

After determining available resources, the example available resource identifier 130 transmits identifiers of the available resources to the example resource score calculator 127. The example resource score calculator 127 then scores the available resources based on matching work placement parameters, resource group preferences, and/or weights. In some examples, the available resource identifier 130 may update the resource score calculator 127 as available resources become available and/or unavailable. In other examples, the available resource identifier 130 provides available resources each time the example resource score calculator 127 calculates scores of resources to fill an open position.

To select a resource to fill an open position, the example resource sourcing processor 102 of FIG. 1 includes a resource selector 132. The example resource selector 132 determines which resource to select to fill an open position by identifying a resource group with a greatest calculated weight and/or highest preference (e.g., a target resource group) that has at least one available resource. Within this target resource group, the example resource selector 132 selects a resource to fill an open position. In some examples, the resource selector 132 may select the resource within the target resource group that has a greatest score determined by the example resource score calculator 127.

In other examples, the resource selector 132 may select a resource among identified available resources that has a greatest score determined by the resource score calculator 127. In these other examples, the score may include adjustments for resource group preferences and/or weights. In yet other examples, the resource selector 132 may be instructed to select a resource that has a score, weight, and/or preference above a predefined threshold. In these other examples, the resource selector 132 may return a ‘no matching resources available’ message to, for example, the workstation 106 if there are no available resources with scores that meet and/or exceed a threshold.

After selecting a resource to fill an open position, the example resource selector 132 transmits a message to, for example, the workstation 106 identifying the selected resource. Alternatively, the example resource selector 132 transmits a message identifying a plurality of resources with a score, weight, and/or preference above a predefined threshold. In these alternatively examples, resource planning personnel may select a resource from among the identified resources. The example resource selector 132 may also update the example resource database 126, the available resource identifier 130, and/or any other resource database within an organization with the information that a selected resource is not longer available (e.g., that the resource has been allocated). The example resource selector 132 may also identify which position has been filled. Additionally, the resource selector 132 may send a message to the open position receiver 128 indicating that the requested open position has been filled.

To accommodate feedback from, for example, resource planning personnel, the example resource sourcing processor 102 of FIG. 1 includes a feedback processor 134. The example feedback processor 134 receives requests (e.g., feedback) from resource planning personnel to select a different resource for a filled position, modify a structure of an organization, modify preferences and/or weights of resource groups in relation to a primary resource group, and/or modify scores for matching work placement parameters. Upon receiving feedback, the example feedback processor 134 identifies the type of feedback and makes the appropriate changes within the resource sourcing processor 102.

For example, when resource planning personnel request a different resource to fill an open position, the feedback processor 134 may identify a resource group of the requested resource and adjust the preference and/or weight to more closely match the open position. In this example, the feedback processor 134 may also modify matching work placement parameter scores based on the newly selected resource. In examples where resource planning personnel modify a structure, preferences, and/or weights, the example feedback processor 134 incorporates the changes into the already determined structure stored in the resource database 126. The feedback processor 134 may then instruct the resource preference processor 124 to recalculate weights and/or re-determine resource group preferences based on the changes provided by the resource planning personnel. In examples where resource planning personnel adjust work placement parameter scores and/or score calculating routines, the example feedback processor 134 communicates the changes to the resource score calculator 127 to use in later requests to fill open positions.

While an example manner of implementing the example system 100 has been illustrated in FIG. 1, one or more of the elements, processes and/or devices illustrated in FIG. 1 may be combined, divided, re-arranged, omitted, eliminated and/or implemented in any other way. Further, the example resource sourcing processor 102, the example server 104, the example workstation 106, the example user interface 108, the example resource structure manager 120, the example resource location manager 122, the example resource preference processor 124, the example resource database 126, the example resource score calculator 127, the example open position receiver 128, the example available resource identifier 130, the example resource selector 132, the example feedback processor 134 and/or, more generally, the example system 100 of FIG. 1 may be implemented by hardware, software, firmware and/or any combination of hardware, software and/or firmware.

Thus, for example, any or all of the example resource sourcing processor 102, the example server 104, the example workstation 106, the example user interface 108, the example resource structure manager 120, the example resource location manager 122, the example resource preference processor 124, the example resource database 126, the example resource score calculator 127, the example open position receiver 128, the example available resource identifier 130, the example resource selector 132, the example feedback processor 134 and/or, more generally, the example system 100 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus claims are read to cover a purely software and/or firmware implementation, at least one of the example resource sourcing processor 102, the example server 104, the example workstation 106, the example user interface 108, the example resource structure manager 120, the example resource location manager 122, the example resource preference processor 124, the example resource database 126, the example resource score calculator 127, the example open position receiver 128, the example available resource identifier 130, the example resource selector 132, and/or the example feedback processor 134 are hereby expressly defined to include a tangible computer readable medium such as a memory, DVD, CD, Blu-ray disc, etc. storing the software and/or firmware. Further still, the system 100 of FIG. 1 may include one or more elements, processes and/or devices in addition to, or instead of, those illustrated in FIG. 1, and/or may include more than one of any or all of the illustrated elements, processes and devices.

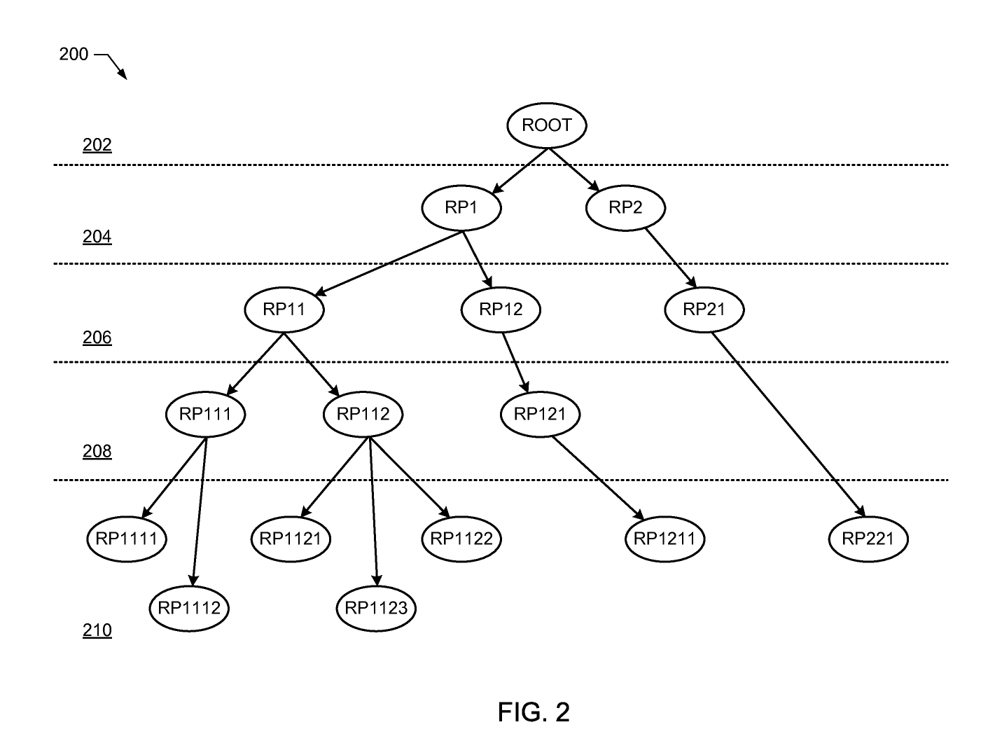

FIG. 2 shows an example structure 200 for the example system 100 of FIG. 1. The example structure 200 is, for example, an organizational hierarchy for an organization and may be determined by the resource structure manager 120. In the example of FIG. 2, the structure 200 includes hierarchy levels 202-210 that provide a framework for linking together resource groups Root-RP1123. In this example, resource groups that are in higher hierarchy levels manage and/or oversee the resource groups that are in directly linked lower hierarchy levels. For example, the resource group RP11 manages the resource groups RP111 and RP112 and the resource group RP111 manages the resource groups RP1111 and RP1112.

The example structure 200 of the illustrated example shows one possible hierarchy for an organization. Other examples can include different numbers of resource groups, different levels of resource groups, different relationships between resource groups, and/or different types of organizational structures. For example, some resource groups may be linked together in a matrix structure or, alternatively, some resource groups may be linked together in a horizontal structure.

In the example of FIG. 2, the structure 200 includes the first hierarchy level 202 with a resource group Root. The resource group Root may correspond to a head and/or leader of an organization. The second hierarchy level 204 includes the resource groups RP1 and RP2, which may correspond to division managers within the organization. The third hierarchy level 206 includes the resource groups RP11, RP12, and RP21, which may correspond to functional managers. The fourth hierarchy level 208 includes the resource groups RP111, RP112, and RP121, which may correspond to project managers. The fifth hierarchy level 210 includes the resource groups RP1111, RP1112, RP1121, RP1122, RP1123, RP1211, and RP221, which may correspond to workers. In this example, the resource groups RP1111-RP221 within the fifth hierarchy level 210 are classified as delivery resource groups because the resource groups RP1111-RP221 include resources that can be allocated. In other examples, the resource groups Root-RP121 within the hierarchy levels 202-208 may include resources that can be allocated.

In the illustrated example, the resource preference processor 124 determines resource group preferences for each of the resource groups Root-RP22. For example, the resource preference processor 124 may determine that resource groups that share a common parent resource group are siblings. In the illustrated example, the resource groups RP111 and RP112 are siblings because they are both directly functionally linked to a higher level parent resource group RP11. In this example, the resource preference processor 124 may determine that the resource group RP121 is a cousin of the resource groups RP111 and RP112 because the resource groups RP111, RP112, and RP121 are functionally linked to a common grandparent resource group RP1. Further, the example resource preference processor 124 may determine that the resource groups RP1111 and RP1112 are children resource groups of the resource group RP111 because the resource groups RP1111 and RP1112 are functionally directly linked one level down from the resource group RP111. In other examples, the example resource preference processor 124 may determine resource group preferences after a request is received to fill an open position.

When, for example a request to fill an open position identifies the resource group RP111 as a primary resource group, the example resource sourcing processor 102 identifies resource group preferences based on the determined relationships (e.g., children, siblings, cousins) between the resource groups. In other examples, the resource sourcing processor 102 may also identify business location resource groups as a fourth preference if there are no available resources within the first three preferences. The example resource preference processor 124 may also weight the resource groups within the structure 200 based on an organizational distance from a primary resource group. For example, the resource group RP12 has an organizational distance of two-hops (e.g., two links) from the resource group RP11. In another example, the resource group RP221 has an organizational distance of seven-hops from the resource group RP1111. In this manner, the example resource sourcing processor 102 of FIG. 1 utilizes the structure 200 of FIG. 2 to determine work placement preferences based on organizational distances to fill an open position.

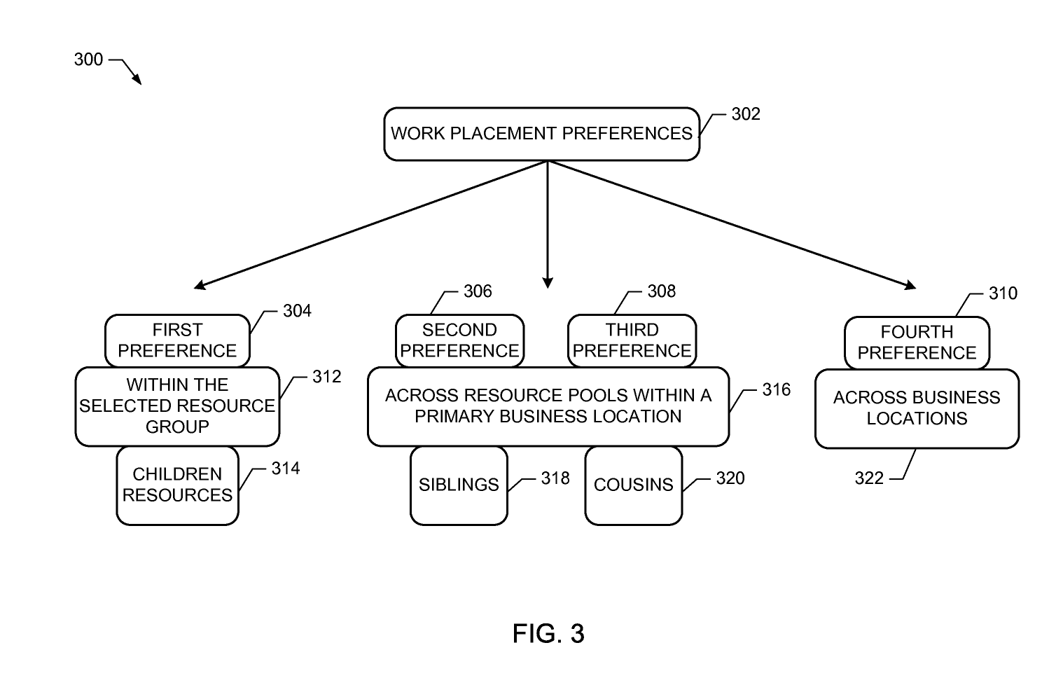

FIG. 3 shows an example work placement preference routine 300 for the example system 100 of FIG. 1. The example work placement preference routine 300 may be implemented by, for example, the resource preference processor 124 of FIG. 1 and/or more generally, the example resource sourcing processor 102. The example routine 300 specifies business rules for determining preferences based on relationships between resource groups. In other examples, the work placement preference routine 300 can be modified based on different organizational structures and/or business rules.

In the illustrated example, the work placement preference routine 300 includes a work placement preferences block 302 that includes (and/or is linked to) a first preference 304, a second preference 306, a third preference 308, and a fourth preference 310. In other examples, the work placement preference routine 300 may include additional or fewer preferences. The example preferences 304-310 specify conditions when resource groups are included within the preferences 304-310 based on functional relationships of the resource groups within, for example, the structure 200 of FIG. 2. The example preferences 304-310 may be defined and/or specified by resource planning personnel. In other examples, the resource sourcing processor 102 may define and/or specify the preferences 304-310 based on, for example, the relationships between the resource groups within the structure 200.

The example first preference 304 is specified as including resource groups within a selected (e.g., primary) resource group rule 312. For example, the first preference includes available resources within a resource group specified for an open position. The selected resource group rule 312 can include any resource group at any level within, for example, the structure 200.

The example first preference 304 also includes a children resource group rule 314. The example children resource group rule 314 specifies, for example, that the first preference 304 also includes available (and/or qualified) resources within resource groups that are children of a primary resource group. In some examples, the children resource group rule 314 may be utilized as the first preference 304 when there are no available (e.g., delivery) resources within a primary resource group.

The example second preference 306 and the example third preference 308 include a rule 316 that specifies a resource group is to be selected that is included within a same business location (e.g., physical location) as the primary resource group. In conjunction with the rule 316, the second preference 306 includes a rule 318 that indicates sibling resource groups are to be selected and the third preference 308 includes a rule 320 that indicates cousin resource groups are to be selected. In other words, the rule 318 indicates that sibling resource groups are classified as the second preference 306 and the rule 320 indicates that cousin resource groups are classified as the third preference 308.

In some examples, the cousin rule 320 may include an additional rule that weights the cousin resource groups based on an organizational distance from the primary resource group. Alternatively, the work placement preferences 302 may include a rule (not shown) that weights the resource groups based on an organizational distance from a primary resource group. In these alternative examples, the work placement preferences 302 may use the weight rule in conjunction with the preferences 304-310.

The example fourth preference 310 of FIG. 3 includes a rule 322 that indicates a resource group is to be selected that is not included within a same location as a primary resource group. In this example, the rule 322 specifies that any resource group within a different location may be included within the fourth preference 310. In other examples, the fourth preference 310 may include additional rules that specify which resource groups within a different location are to be preferred over other resource groups. Alternatively, the work placement preferences 302 and/or the fourth preference 310 may include a weight rule that uses organizational distance to determine which different business location resource groups are to be preferred.

By using the example preferences 304-310 of the illustrated example, the resource sourcing processor 102 determines which resource groups are preferred in relation to other resource groups via the work placement preferences 302. The example resource sourcing processor 102 may then use the work placement preferences 302 to determine which resource to fill an open position. In this manner, the example work placement preference routine 300 quickly and efficiently allocates resources within an organization based on work placement preferences.

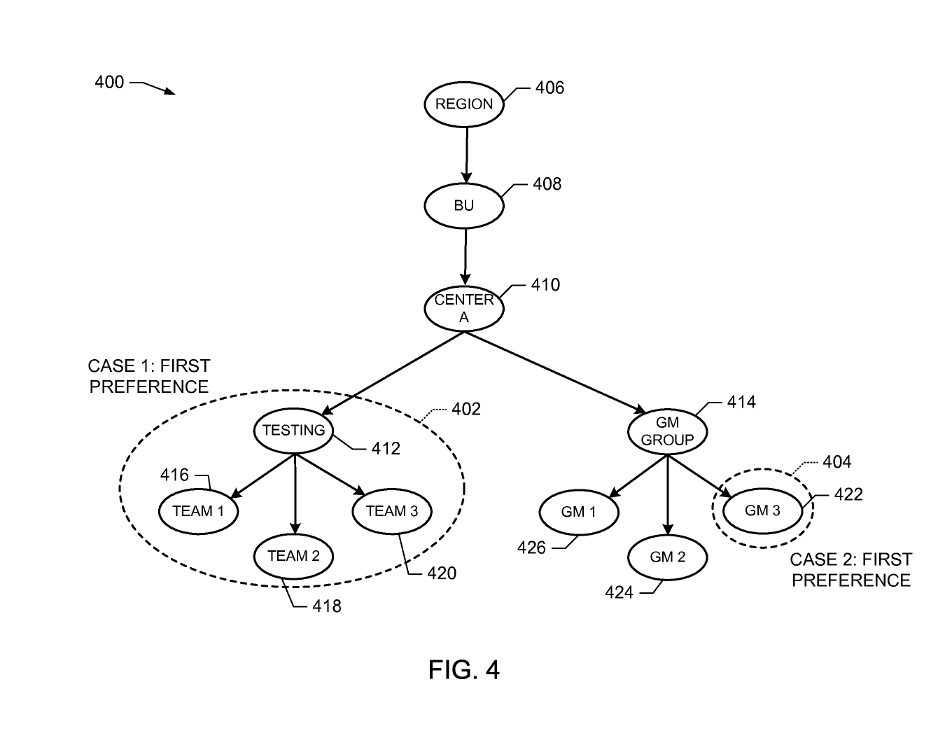

FIG. 4 shows an example structure 400 including example first preferences 402 and 404 (e.g., the first preference 304 of FIG. 3) for two different example work placement cases. The work placement case 1 corresponds to a request to fill an open position with an individual with testing experience. The work placement case 2 corresponds to a request to fill an open position with an individual with maintenance experience. In other examples, cases may correspond to requests to fill other types of positions.

The example structure 400 may be determined by, for example, the resource structure manager 120 of FIG. 1. The example structure 400 includes a region business resource group 406 that manages a business unit (BU) resource group 408. The example business unit resource group 408 manages a center A resource group 410, which manages a testing resource group 412 and a general maintenance (GM) resource group 414. The testing resource group 412 manages three teams of testing resource groups 416-420 and the general maintenance resource group 414 manages three teams of maintenance resource groups 422-426.

In the illustrated example, the work placement case 1 corresponds to a resource request that indicates the testing resource group 412 as the primary resource group to fill an open position. Because the testing resource group 412 was selected as the primary resource group to fill an open position, a resource may be selected equally from among the testing team resource groups 416-420. Additionally, because the testing resource group 412 does not include workers (e.g., available resources), the first preference 402 includes the testing team resource groups 416-420, which are children of the testing resource group 412. In other words, by requesting the testing resource group 412 as the primary resource group, the example resource sourcing processor 102 includes the children resource groups 416-420 as the first preference 402 because the groups 416-420 include available resources (e.g., testers).

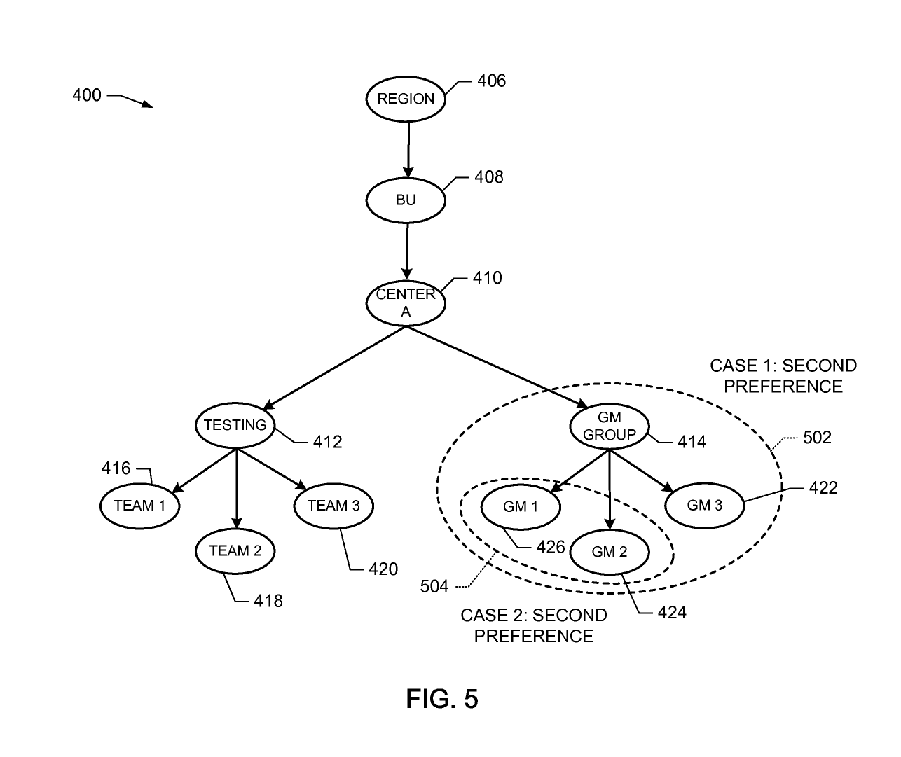

In this example, the resource sourcing processor 102 may select an available resource from any of the team resource groups 416-420 for the work placement case 1 to fill an open position. Additionally, the resource sourcing processor 102 may calculate a score for the available resources within the resource groups 416-420 based on matching work placement parameters and select the available resource with the relatively highest score. If there are no available resources within the team resource groups 416-420, the example resource sourcing processor 102 may identify second preference resource groups as described in conjunction with FIG. 5. In other examples, the resource sourcing processor 102 may determine which resource groups correspond to which preferences prior to selecting a resource.

In the example of FIG. 4, the work placement case 2 corresponds to a selection of the general maintenance team 3 resource group 422 as a primary resource group to fill an open position. In this example, the first preference 404 includes only the general maintenance team 3 resource group 422 because the group 422 was selected as the primary resource group and includes available (deliverable) resources (e.g., maintenance workers). The example resource sourcing processor 102 determines if the general maintenance team 3 resource group 422 includes available resources. If the resource group 422 does not include available resources, the resource sourcing processor 102 determines if second preference resource groups include available resources, as described in conjunction with FIG. 5.

FIG. 5 shows the example structure 400 of FIG. 4 including example second preferences 502 and 504 (e.g., the second preference 306 of FIG. 3) for the two example work placement cases. In this example, the second preferences 502 and 504 correspond to siblings of the respective selected primary resource groups 412 and 404. In other words, the example resource preference processor 124 identifies resource groups that are two-hops away from the primary resource groups. The example second preferences 502 and 504 may be determined by the example resource preference processor 124 after determining the first preferences 402 and 404 of FIG. 4.

In the illustrated example, the example resource preference processor 124 determines that for the work placement case 1 the general maintenance resource group 414 is a sibling of the testing resource group 412. The example resource preference processor 124 determines that the general maintenance resource group 414 is a management resource group and does not include any deliverable (e.g., available resources). Thus, the example resource preference processor 124 includes the children general maintenance team resource groups 422-426 that include deliverable and/or available resources within the second preference 502.

In the example structure 400 of FIG. 5, the resource preference processor 124 determines that for the work placement case 2 the general maintenance resource groups 424 and 426 are siblings of the primary resource group 422. Because the general maintenance resource groups 424 and 426 include deliverable resources, the example resource preference processor 124 includes the groups 424 and 426 within the second preference 504. In this manner, the resource selector 132 may select resources within the resource groups 424 and 426 as the second preference 504 and resources within the resource group 422 as the first preference 404.

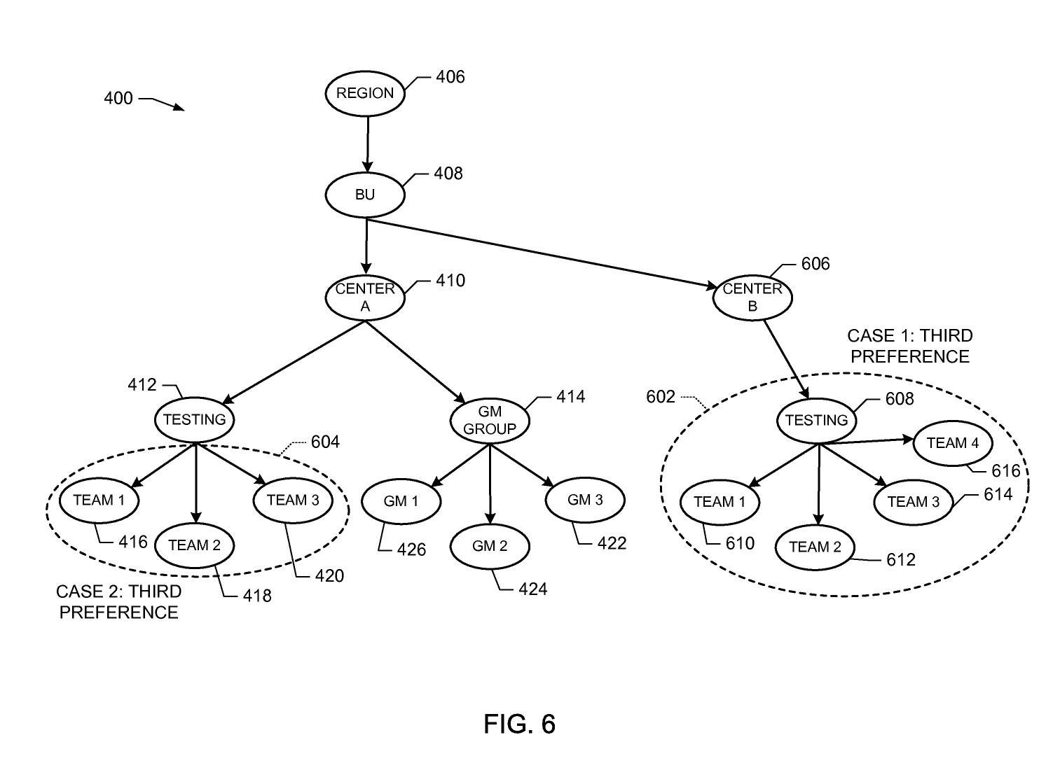

FIG. 6 shows the example structure 400 of FIGS. 4 and 5 including example third preferences 602 and 604 (e.g., the third preference 308 of FIG. 3) for the two example work placement cases. In this example, the third preferences 602 and 604 correspond to cousin resource groups of the respective selected primary resource groups 412 and 422. In other words, the example resource preference processor 124 of FIG. 1 identifies resource groups that are at least three hops away from the primary resource groups 412 and 422. In some examples, the third preferences 602 and 604 may be located at the same business location or, alternatively, a different business location from the primary resource groups 412 and 422. The example third preferences 602 and 604 may be determined by the example resource preference processor 124 after determining the first preferences 402 and 404 of FIG. 4 and the second preferences 502 and 504 of FIG. 5.

In the illustrated example, the example structure 400 includes a center B resource group 606 that is managed by the business unit resource group 408. The example center B resource group 606 manages a testing resource group 608, which manages four testing team resource groups 610-616. The example resource preference processor 124 determines that the testing resource group 608 is a cousin resource group of the selected primary resource group 412. The example resource groups 412 and 608 are cousins because the resource groups 412 and 608 are linked to a common grandparent resource group 408 and are separated by at least 3 hops of organizational distance. Further, because the testing resource group 608 is a management resource group and does not include deliverable resources, the testing team resource groups 610-616 are included within the third preference 602 for the work placement case 1.

In examples where the resource preference processor 124 determines that the testing resource group 412 has multiple cousin resource groups, the resource preference processor 124 may calculate weights for the cousin resource groups based on an organizational distance from the testing resource group 412. The weights may be used in conjunction with the third preference 602 by the example resource selector 132 to select an available resource with a relatively high weight among the available resources within resource groups classified as the third preference 602.

In the illustrated example of FIG. 6, the resource preference processor 124 also determines that the testing team resource groups 416-420 are cousins of the resource group 422. The example resource preference processor 124 classifies these resource groups 416-420 as the third preference 604 for the work placement case 2. In other words, resources associated with the testing team resource groups 416-420 are equally preferred as the third preference 604 to fill an open position for the work placement case 2.

In some examples, the example resource preference processor 124 may determine that the testing team resources 610-616 are also a third preference of the primary resource group 422. In these examples, the resource preference processor 124 may determine that because the testing team resource groups 610-616 have a greater organizational distance from the primary resource group 422 than the testing team resource groups 416-420, the resource groups 610-616 have a relatively lower weight than the resource groups 416-420. As a result, the resource selector 132 selects available resources from the resource groups 416-420 to fill an open position as the third preference 604 before selecting available resources from the resource groups 610-616.

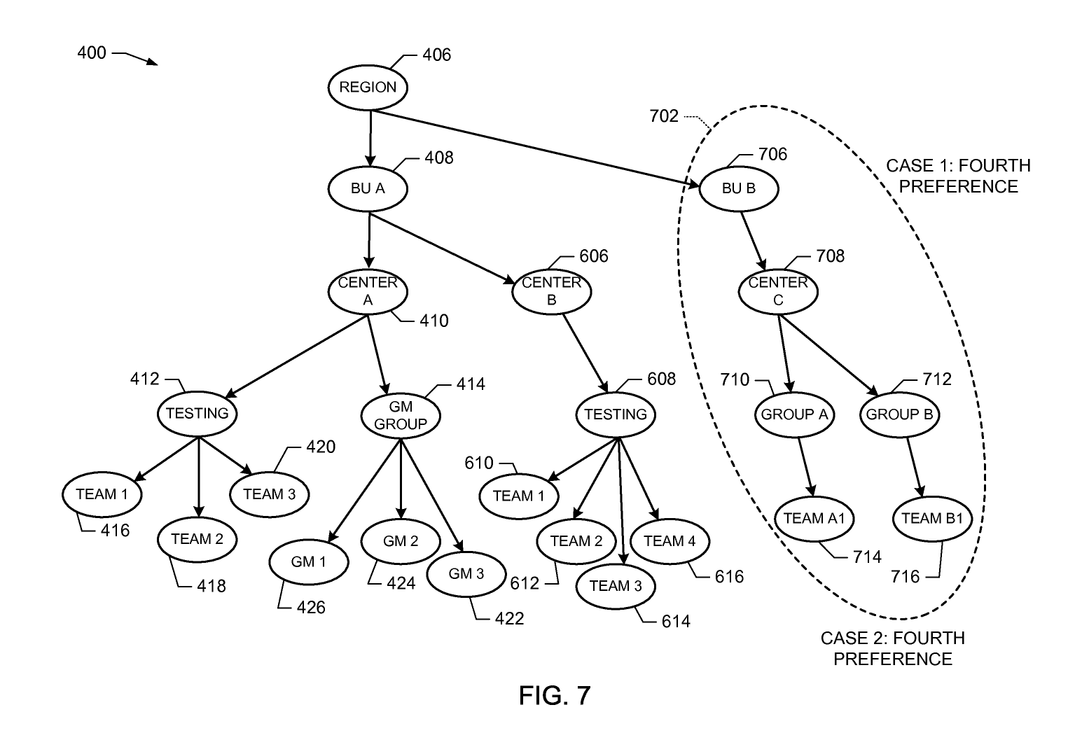

FIG. 7 shows the example structure 400 of FIGS. 4-6 including an example fourth preference 702 (e.g., the fourth preference 310 of FIG. 3) for the two example work placement cases. In this example, the structure 400 includes a business unit resource group 706 that is managed by the region business resource group 406. The example business unit resource group 706 manages a center C resource group 708, which manages a group A resource group 710 and a group B resource group 712. The group resource groups 710 and 712 manage respective team resource groups 714 and 716.

In the illustrated example, the example resource group 706-716 are located at a different business location (e.g., physical location) from the business unit resource group 408. The different location may include another country, another geographical region, another continent, another state, another city, etc. In other examples, the structure 400 may include other locations.

In the example of FIG. 7, the resource preference processor 124 determines the fourth preference 702 by identifying a location different from the location of the primary resource groups 412 and 422. The resource preference processor 124 includes the resource groups 706-716 within the fourth preference 702 because the resource groups 706-716 are associated with the other location. In other examples, the resource preference processor 124 may include resource groups (e.g., the resource groups 714 and 716) within the fourth preference 702 that include available and/or deliverable resources. Additionally, the example resource preference processor 124 may calculate weights for each of the resource groups 706-716 based on an organizational distance from the respective primary resource groups 412 and 422 to fill open positions associated with the work placement cases.

Using the example preferences 402, 502, 602, and 702, the example resource preference processor 124 can determine which resource to fill an open position for the work placement case 1. The example resource preference processor 124 uses the example preferences 404, 504, 604, and 702 to determine which resource to fill an open position for the work placement case 2. In some examples, the resource preference processor 124 may assign a first weight to the first preferences 402 and 404, a second weight to the second preferences 502 and 504, a third weight to the third preferences 602 and 604, and a fourth weight to the fourth preference 702. These weights may then be averaged and/or otherwise combined with organizational distance weights to determine a total weight for each resource group.

In other examples, the resource score calculator 127 may determine scores for the resources based on work placement parameters matching work placement parameters specified within a request for an open position. In these examples, the resource score calculator 127 combines the calculated score with the respective preferences 402, 404, 502, 504, 602, 604, and 702 and/or any calculated weights. The example resource selector 132 may then select an available resource with the highest calculated adjusted score to fill an open position.

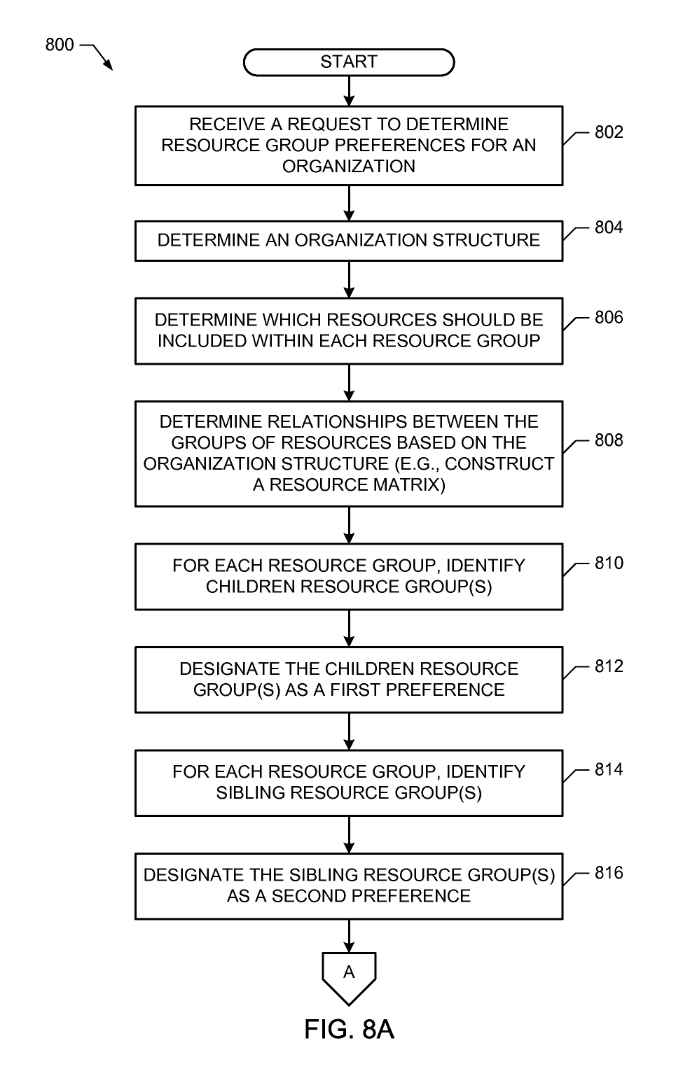

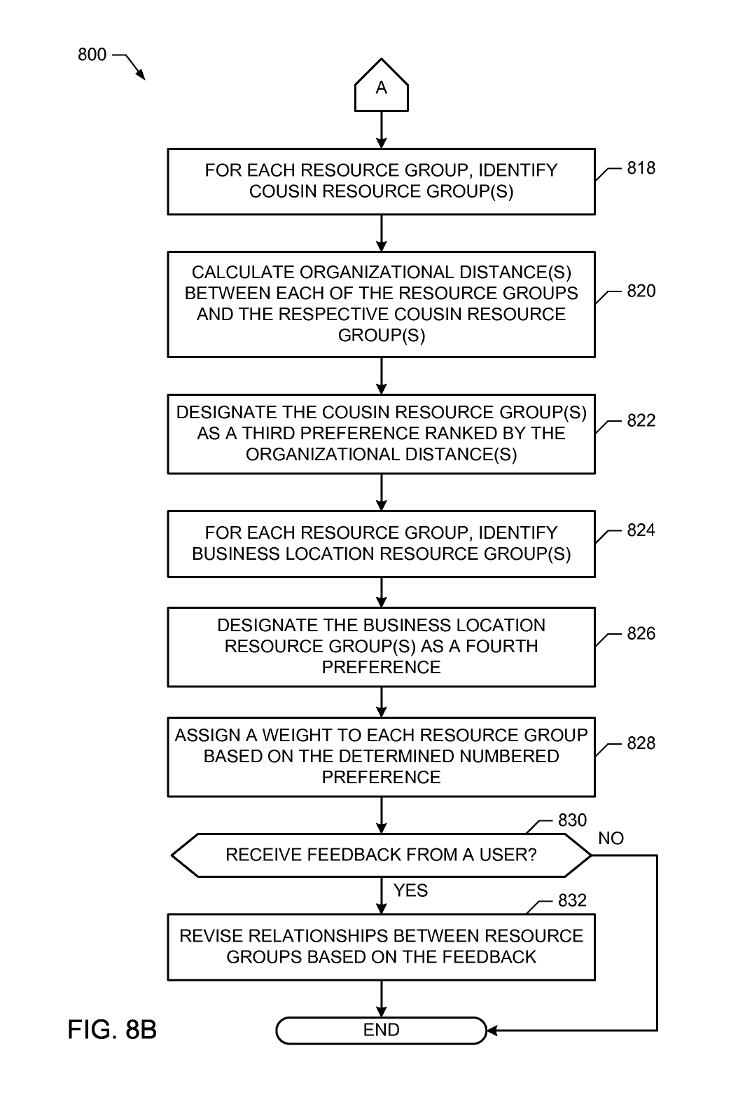

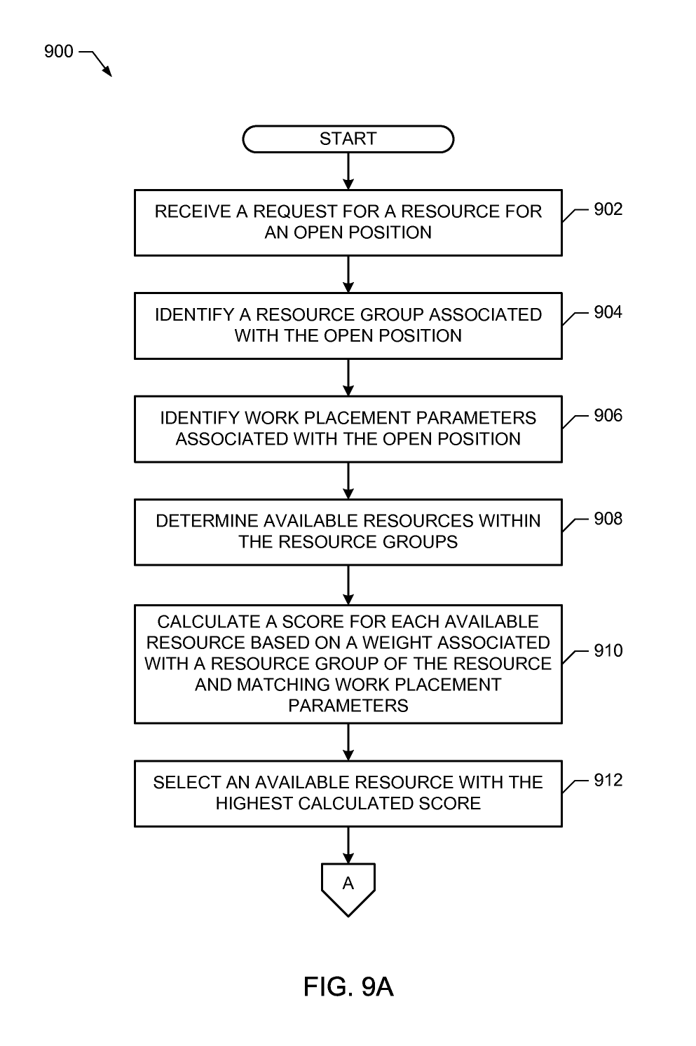

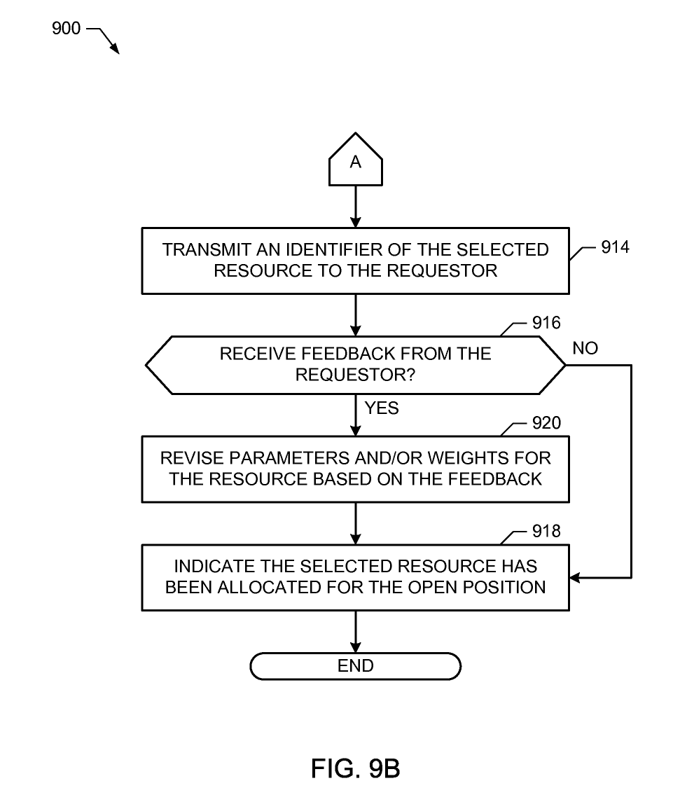

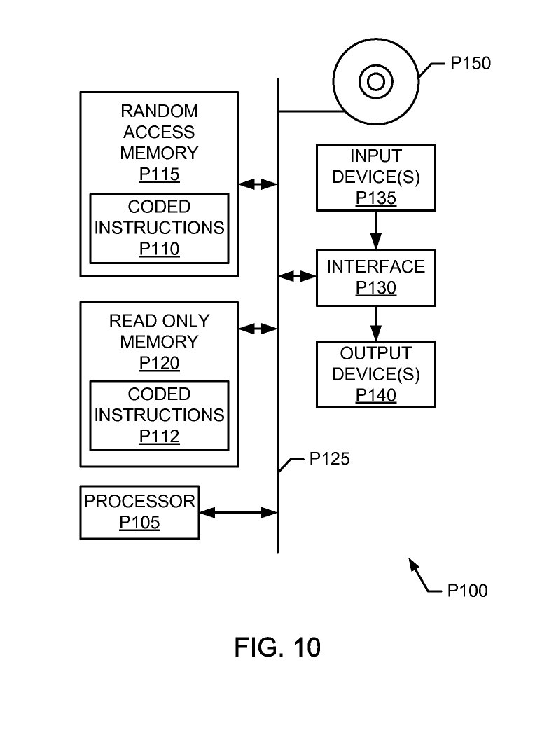

A flowchart representative of example machine readable instructions for implementing the resource sourcing processor 102 of FIG. 1 is shown in FIGS. 8A, 8B, 9A, and 9B. In this example, the machine readable instructions comprise a program for execution by a processor such as the processor P105 shown in the example processor platform P100 discussed below in connection with FIG. 10. The program may be embodied in software stored on a computer readable medium such as a CD, a floppy disk, a hard drive, a DVD, Blu-ray disc, or a memory associated with the processor P105, but the entire program and/or parts thereof could alternatively be executed by a device other than the processor P105 and/or embodied in firmware or dedicated hardware. Further, although the example program is described with reference to the flowcharts illustrated in 8A, 8B, 9A, and 9B, many other methods of implementing the example resource sourcing processor 102 may alternatively be used. For example, the order of execution of the blocks may be changed, and/or some of the blocks described may be changed, eliminated, or combined.

As mentioned above, the example machine readable instructions of 8A, 8B, 9A, and 9B may be implemented using coded instructions (e.g., computer readable instructions) stored on a tangible computer readable medium such as a hard disk drive, a flash memory, a ROM, a CD, a DVD, a Blu-ray disc, a cache, a RAM and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of 8A, 8B, 9A, and 9B may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

The example machine-readable instructions 800 of FIGS. 8A and 8B determine preferences and/or weights for resource groups based on an organizational structure. In some examples, the example instructions 800 may create a resource group preference matrix based in an organizational structure. The example instructions 800 of FIG. 8A begin when the example resource structure manager 120 receives a request to determine resource group preferences for an organization (block 802). The request may be for a primary resource group selected to fill an open position. Alternatively, the request may be to determine preferences for each resource group within an organization.

The example resource structure manager 120 and/or the resource location manager 122 determine an organizational structure (e.g., the structure 400 of FIGS. 4-7) based on organization information provided from, for example, resource planning personnel (block 804). The example resource structure manager 120 and/or the resource location manager 122 then determine which resources should be included within each resource group (block 806). The example resource preference processor 124 next determines relationships between the resource groups based on the organizational structure (block 808). In some instances, the example resource preference processor 124 may determine a resource group preference matrix with different preferences of resource groups for each resource group.

For each resource group, the example resource preference processor 124 determines children resource group(s) (block 810) and designates those resource group(s) as a first preference (e.g., the first preferences 402 and 404) (block 812). The example resource preference processor 124 then identifies sibling resource group(s) for each resource (block 814). The resource preference processor 124 classifies these sibling resource group(s) as a second preference (e.g., the second preferences 502 and 504) (block 816).

In FIG. 8B, the example resource preference processor 124 determines cousin resource group(s) for each resource group (block 818). The example resource preference processor 124 then calculates organizational distances between each resource group and the respective cousin resource group(s) to determine weight(s) for the cousin resource group(s) (block 820). The example resource preference processor 124 designates these cousin resource group(s) as a third preference and ranks these resource group(s) based on the determined weight(s) (block 822).

The example resource preference processor 124 continues by identifying different business location resource group(s) in relation to each resource group (block 824). The example resource preference processor 124 then designates the business location resource group(s) as a fourth preference (block 826). In some examples, the resource preference processor 124 may calculate weights for resource groups within the fourth preference based on a distance from each of the resource group(s). The example resource preference processor 124 then assigns a weight to each resource group based on the preference associated with the resource group (block 828). In examples where the resource group(s) include a weight from an organizational distance, the weight associated with the preference may be combined and/or averaged with the organizational distance weights. In some examples, the resource preference processor 124 may then store the preferences, weights, structure, and/or a resource group preference matrix to, for example, the resource database 126.

The example feedback processor 134 may then determine if feedback has been received from, for example, resource planning personnel (block 830). The feedback may include, for example, changes to preferences assigned to resource groups, weights assigned to resource groups, changes to the organizational structure, and/or functional relationships between the resource groups. In some instances, the feedback may be received in response to changes to the organization. If feedback was not received from resource planning personnel, the example instructions 800 terminate. In other instances, the example instructions 800 may wait until feedback is received and/or create a new structure for another organization.

However, if resource planning personnel provide feedback, the example feedback processor 134 instructs the resource preference processor 124 to revise the preferences, weights, structure, and/or resource group relationships based on the feedback (block 832). The example instructions 800 may then terminate. In other instances, the example instructions 800 may wait until feedback is received and/or create a new structure for another organization.

The example machine-readable instructions 900 of FIGS. 9A and 9B determine a resource to fill an open position based on work placement preferences of an organization. The example instructions 900 of FIG. 9A begin by the example open position receiver 128 of FIG. 1 receiving a request for a resource to fill an open position (block 902). The example open position receiver 128 then identifies a resource group (e.g., a primary resource group) associated with the open position (block 904). In some instances, the primary resource group may be requested to fill the position. In other instances, the open position is included within the primary resource group.

The example instructions 900 of the illustrated example continue by the open position receiver 128 and/or the resource score calculator 127 determining work placement parameters associated with the open position (block 906). The example resource score calculator 127 then accesses the available resource identifier 130 to determine available resources within resource groups of the organization (block 908). The example resource score calculator 127 next accesses the resource database 126 for a structure, resource group preferences and/or weights, and/or resource work placement parameters. The example resource calculator 127 then calculates a score for each available resource using the structure, resource group preferences and/or weights, and/or resource work placement parameters (block 910). The example resource selector 132 uses the calculated scores to select an available resource with the highest score (block 912).

The example instructions 900 of FIG. 9B continue by the example resource selector 132 transmitting an identifier of the selected resource to the requestor (e.g., resource planning personnel) (block 914). The example feedback processor 134 then determines if feedback was received from the requestor (and/or any other resource planning personnel) (block 916). The feedback can include, for example, a selection of a different resource to fill the open position. If feedback was not received, the example resource selector 132 indicates that the selected resource has been allocated for the open position (block 918). The example instructions 900 may then terminate. In other examples, the example instructions 900 may return to receiving a request to fill an open position (block 902).

If feedback was received from the requestor, the example feedback processor 134 adjusts work placement parameters, weights, and/or preferences for the previously selected resource and/or the newly selected resource (block 920). For example, the feedback processor 134 may lower weights and/or reduce preferences for resource groups associated with a resource that was manually replaced by a requestor. In other examples, the feedback processor 134 may instruct the example resource score calculator 127 to reduce matching scores of work placement parameters for the resource that was replaced by a requestor. The example resource selector 132 then indicates that the resource selected by the requestor has been allocated for the open position (block 918). The example instructions 900 may then terminate. In other examples, the example instructions 900 may return to receiving a request to fill an open position (block 902).

FIG. 10 is a schematic diagram of an example processor platform P100 that may be used and/or programmed to execute the example machine readable instructions 800 and 900 of FIGS. 8A, 8B, 9A, and/or 9B. One or more general-purpose processors, processor cores, microcontrollers, etc may be used to implement the processor platform P100.

The processor platform P100 of FIG. 10 includes at least one programmable processor P105. The processor P105 may implement, for example, the example resource sourcing processor 102, the example server 104, the example workstation 106, the example user interface 108, the example resource structure manager 120, the example resource location manager 122, the example resource preference processor 124, the example resource database 126, the example resource score calculator 127, the example open position receiver 128, the example available resource identifier 130, the example resource selector 132, and/or the example feedback processor 134 of FIG. 1. The processor P105 executes coded instructions P110 and/or P112 present in main memory of the processor P105 (e.g., within a RAM P115 and/or a ROM P120) and/or stored in the tangible computer-readable storage medium P150. The processor P105 may be any type of processing unit, such as a processor core, a processor and/or a microcontroller. The processor P105 may execute, among other things, the example interactions and/or the example machine-accessible instructions 800 and 900 of FIGS. 8A, 8B, 9A, and/or 9B to determine work placement preferences, as described herein. Thus, the coded instructions P110, P112 may include the instructions 800 and 900 of FIGS. 8A, 8B, 9A, and/or 9B.

The processor P105 is in communication with the main memory (including a ROM P120 and/or the RAM P115) via a bus P125. The RAM P115 may be implemented by dynamic random access memory (DRAM), synchronous dynamic random access memory (SDRAM), and/or any other type of RAM device, and ROM may be implemented by flash memory and/or any other desired type of memory device. The tangible computer-readable memory P150 may be any type of tangible computer-readable medium such as, for example, compact disk (CD), a CD-ROM, a floppy disk, a hard drive, a digital versatile disk (DVD), and/or a memory associated with the processor P105. Access to the memory P115, the memory P120, and/or the tangible computer-medium P150 may be controlled by a memory controller.

The processor platform P100 also includes an interface circuit P130. Any type of interface standard, such as an external memory interface, serial port, general-purpose input/output, etc, may implement the interface circuit P130. One or more input devices P135 and one or more output devices P140 are connected to the interface circuit P130.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent either literally or under the doctrine of equivalents.

What is claimed is:

1. A method to determine work placement preferences, comprising:
receiving, via a processor, a request for a resource to fill an open position within an organization, the request including a primary resource group for the open position;
determining with the processor resource group preferences of resource groups using a structure of the organization that includes functional relationships between the resource groups;
calculating weights for the resource group preferences based on respective organizational distances in the structure of the respective resource groups from the primary resource group;
determining a target resource group with a greatest calculated weight for a resource group preference from among the resource groups that have at least one available resource; and
selecting a resource within the target resource group to fill the open position.

2. A method as defined in claim 1, wherein determining the resource group preferences includes determining a first resource group preference by identifying a first resource group that is a child resource group of the primary resource group.

3. A method as defined in claim 2, wherein determining the resource group preferences further comprises:
determining a second resource group preference by identifying a second resource group that is a sibling resource group of the primary resource group;
determining a third resource group preference by identifying a third resource group that is a cousin resource group of the primary resource group; and
determining a fourth resource group preference by identifying a fourth resource group that is a different location resource group from the primary resource group.

4. A method as defined in claim 1, further comprising:
calculating a score for the available resources in the resource groups based on work placement parameters of the available resources matching work placement parameters specified within the request; and
adjusting the score for the available resources based on the calculated weights of the corresponding resource group preferences.

5. A method as defined in claim 4, wherein selecting the resource includes selecting the resource with a greatest adjusted score among the available resources.

6. A method as defined in claim 4, wherein the work placement parameters include at least one of a location, a business domain, a job level, a skill group, a workforce type, a travel preference, an education level, a promotion trend, or a job type.

7. A method as defined in claim 1, further comprising:
receiving feedback modifying the structure and changing the weight for the at least primary resource group;
determining the resource group preferences based on the feedback; and
calculating the weight for the resource group preferences based on the received feedback and the determined resource group preferences.

8. An apparatus to determine work placement preferences, comprising:
a resource preference manager to:
determine resource group preferences of resource groups using a structure of an organization that includes functional relationships between the resource groups; and
calculate weights for the resource group preferences based on respective organizational distances in the structure of the respective resource groups from a primary resource group, the primary resource group being indicated by a request to fill an open position; and
a resource selector to:
determine a target resource group with a greatest calculated weight for a resource group preference from among the resource groups that have at least one available resource; and
select a resource within the target resource group to fill the open position.

9. An apparatus as defined in claim 8, further comprising an open position receiver to receive the request for the resource to fill the open position.

10. An apparatus as defined in claim 8, wherein the resource preference processor is to determine the resource group preferences by determining a first resource group preference by identifying a first resource group that is a child resource group of the primary resource group.

11. An apparatus as defined in claim 10, wherein the resource preference processor is to determine the resource group preferences by:
determining a second resource group preference by identifying a second resource group that is a sibling resource group of the primary resource group;
determining a third resource group preference by identifying a third resource group that is a cousin resource group of the primary resource group; and
determining a fourth resource group preference by identifying a fourth resource group that is a different location resource group from the primary resource group.

12. An apparatus as defined in claim 8, further comprising a resource score calculator to:
calculate a score for the available resources in the resource groups based on work placement parameters of the available resources matching work placement parameters specified within the request; and
adjust the score for the available resources based on the calculated weights of the corresponding resource group preferences.

13. An apparatus as defined in claim 12, wherein the resource selector is to select the resource by selecting the resource with a greatest adjusted score among the available resources.

14. An apparatus as defined in claim 8, further comprising a resource structure manager to:
retrieve the structure of the organization; and
determine the organizational distances between the resource groups based on information from the organization.

15. An apparatus as defined in claim 8, further comprising a feedback processor to receive feedback modifying the structure and changing the weight for the at least primary resource group.

16. An apparatus as defined in claim 8, wherein the resource preference processor is to:
determine resource group preferences based on the feedback; and
calculate the weight for the resource group preferences based on the received feedback and the determined resource group preferences.

17. A tangible article of manufacture storing machine-readable instructions that, when executed, cause a machine to at least:
access a hierarchal structure of an organization including functional relationships between a resource groups;
determine resource group preferences of the resource groups using the hierarchal structure based on a primary resource group identified in a request for a resource to fill an open position;
calculate weights for the resource group preferences based on respective organizational distances in the hierarchal structure of the respective resource groups from the primary resource group;
determine a target resource group with a greatest calculated weight for a resource group preference from among the resource groups that have at least one available resource; and
select a resource within the target resource group to fill the open position.

18. A tangible article of manufacture as defined in claim 17, wherein the machine-readable instructions, when executed, cause the machine to:
calculate a score for the available resources in the resource groups based on work placement parameters of the available resources matching work placement parameters specified within the request; and
adjust the score for the available resources based on the calculated weights of the corresponding resource group preferences.

19. A tangible article of manufacture as defined in claim 17, wherein the machine-readable instructions, when executed, cause the machine to determine the resource group preferences by determining a first resource group preference by identifying a first resource group that is a child resource group of the primary resource group.

20. A tangible article of manufacture as defined in claim 19, wherein the machine-readable instructions, when executed, cause the machine to:
determine a second resource group preference by identifying a second resource group that is a sibling resource group of the primary resource group;
determine a third resource group preference by identifying a third resource group that is a cousin resource group of the primary resource group; and
determine a fourth resource group preference by identifying a fourth resource group that is a different location resource group from the primary resource group.
